(19) United States
(12) Patent Application Publication
(10) Pub. No.: US 2015/0189416 A1
(43) Pub. Date: Jul. 2, 2015

(54) Headphone Plug Apparatus

(71) Applicant: Timothy Val Kolton, Hollywood, CA (US)

(72) Inventor: Timothy Val Kolton, Hollywood, CA (US)

(21) Appl. No.: 14/145,405

(22) Filed: Dec. 31, 2013

(51) Int. Cl. H04R 1/06; H04R 1/10

(52) U.S. Cl. CPC H04R 1/06; H04R 1/10

(57) ABSTRACT

A headphone having two earpieces, each earpiece having a audio jack, and a plug adapted to releasably engage the audio jack and when inserted into the audio jack, creating a substantially air-tight seal. The plug is molded from a resilient material, such that it may be slightly deformed when inserted tightly into the headphone earpiece and retain its original shape when removed. The plug includes a tab for engaging the interior of the headphone and locking the plug in position. The plug also includes raised indicia such as a logo, shaped such that a user can grasp and rotate the indicia to insert and lock the plug in place.

### BACKGROUND

Headphones are known in the art and typically include two earpieces with an audio cord leading to an audio source. More recently developed headphones have been engineered so that the audio cord can be removed from an earpiece. This development allows headphones to have an audio jack in each earpiece able to accommodate an audio cord, making the headphones adaptable for a cord to be inserted on either the left or right side of the headphones. The positioning of the audio cord to the left or right of the headphones usually depends on the position of the audio equipment from which the audio cord extends.

Audio jacks in the earpieces typically allow ingress and egress of air between the headphone and the atmosphere. Air may be driven in and out of the headphone by the movement of the transducer cone. This movement is increased in larger over-ear headphones because of the increased size of the transducer along with substantial movement generated by bass signals. Since an audio plug typically occludes the audio jack in an earpiece, making the audio jack air-tight, the difference in air movement between an earpiece occluded by an audio jack and an earpiece with an open audio jack may be substantial. For this reason, there is a difference in fidelity between the two earphones in operation.

There is therefore a need for a headphone which has two earpieces, each bearing an audio jack, thereby allowing an audio cord to be plugged into either audio jack, that also solves the problem of differential fidelity between the earpieces when in use. There is also a need for a headphone that preserves fidelity between earpieces that allows the audio jack to be switched from earpiece to earpiece easily and conveniently, while preserving balanced fidelity.

### SUMMARY

Equalizing sound is accomplished in a headphone having two earpieces by providing in each earpiece a contact region having electrical audio contacts for receiving and engaging an audio jack, and a plug region without contacts and having substantially smooth walls for receiving and engaging a plug. Ideally the plug region is in communication with outer portion of each earpiece. A plug is provided for releasably engaging the plug region, and preferably, when inserted into the plug region, creates an air-tight seal.

In a preferred embodiment, the plug is cylindrical, the absence of corners helping to create the air-tight seal. Preferably the plug is molded from a resilient material, such as rubber or silicone such that it may be slightly deformed when inserted firmly into the headphone earpiece and retain its original shape when removed. The plug may also include a hollow bore which is open on a side of the plug facing into the headphone. The bore helps in two ways. First, the bore, in lieu of excess material, makes manufacturing the plug less costly. Second, the bore makes the plug more deformable on the side facing away from the headphone which allows it to be more easily inserted and removed by a user.

Preferably, plug includes a tab for engaging the interior of the headphone. In one embodiment, the tab may form part of a tab-and-slot arrangement, the slot being formed on the plug region of the headphone just below the earpiece contact region. The plug may be formed as a cylinder, which defines an outer circumference. In this arrangement the tab is disposed on the outer circumference. Ideally the tab will be disposed adjacent a side of the plug facing toward the headphone.

Preferably the plug also comprises a raised indicia. The raised indicia may comprise a logo or other three dimensional indicia. Preferably the raised indicia may be shaped such that a user can grasp and rotate the indicia, allowing the plug to be rotated and thereby rotating the position of the tab. The raised indicia preferably may be disposed on a surface of the plug facing away from the headphone. The pressure fit between the plug and the plug region is such that the plug will not move unless rotated by the raised indicia.

In order to use the headphone and plug, a user first obtains a set of headphones, wherein each headphone comprises an audio jack receptacle. The audio jack receptacles are interchangeable, such that plugging an audio connecter into either audio jack results in the transmission of stereo sound. In addition to the jack receptacles, a plug is provided along with the audio cable for sound.

To listen to the headphones, a user inserts an audio jack into one of the receptacles on a first earpiece of the headphones and inserts the plug into the remaining receptacle on a second earpiece of the headphones. Audio signal is then transmitted through the audio jack, and while the audio jack occludes one receptacle, the plug occludes the corresponding receptacle, thereby equalizing the sound between the earpieces. Depending on how a user wants an audio cord oriented, the plug may be removed from the second earpiece and an audio jack inserted into the second earpiece, and the audio jack removed from the first earpiece and a plug inserted into the first earpiece to reverse the orientation.

### BRIEF DESCRIPTION OF THE FIGURES

FIG. 1 is a front perspective view of a plug for the audio jack of a headphone earpiece.

FIG. 2 is a rear perspective view of a plug for the audio jack of a headphone earpiece.

FIG. 3 is a cut-away side view of a plug for the audio jack of a headphone earpiece.

FIG. 4 is a perspective view of a set of headphones having an audio cord and a plug.

### REFERENCE NUMBERS

10. plug
12. cylindrical wall
14. tab
16. raised indicia
18. bore
20. contact-facing side
22. bevel
24. headphones
26. earpiece
28. audio jack
30. audio cord
32. audio plug

### DESCRIPTION

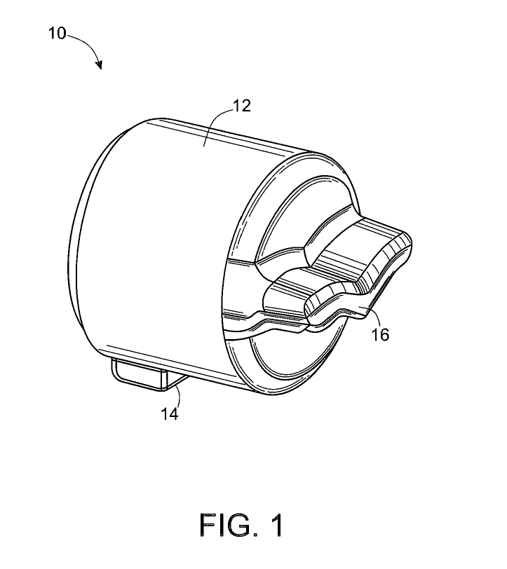

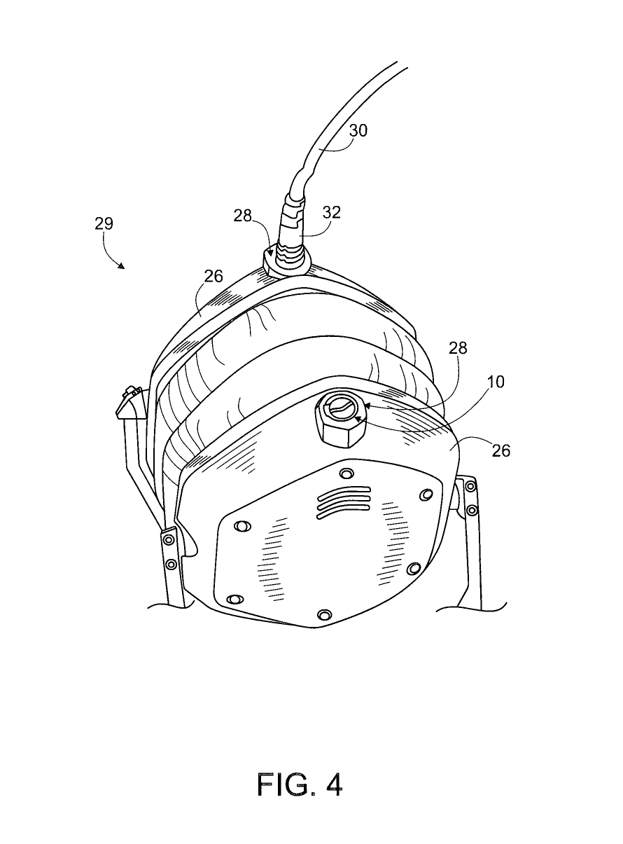

Referring to FIG. 1, a plug 10 for the audio jack of a headphone earpiece 26 (see FIG. 4) is shown. As shown, the plug 10 is a substantially barrel-shaped cylinder 12, having a curved circumference. A tab 14 extends from the circumference and is adapted to engage the headphone earpiece 26 in a locking configuration. A raised indicia 16 is disposed on one end of the plug 10 and serves as both an indicia to reflect branding or other information, and also as a handle for grasping and turning the plug 10. The plug 10 is in communication with the audio jack 28 (see FIG. 4) of each earpiece. While the plug releasably engages the audio jack 28, when inserted into the plug region, it creates an air-tight seal.

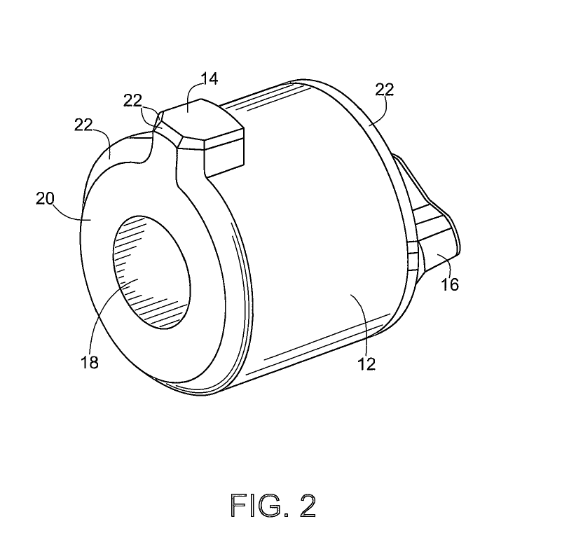

Referring to FIG. 2, the contact-facing side 20 of the plug 10 opposite the raised indicia 16 comprises a bore 18. The bore 18 serves to lessen the amount of material used to produce the plug 10, but also serves to allow the plug to slightly deform when inserted and removed from an audio jack 28 (see FIG. 4). In this manner, the plug may be more easily inserted and removed, and added resiliency is conferred for keeping the plug inserted. To aid in the insertion process, the plug 10 may include beveled edges 22 which help urge the plug 10 into alignment with the audio jack 28. The tab 14 may also include beveled edges to assist in aligning the tab 14 within the audio jack 28.

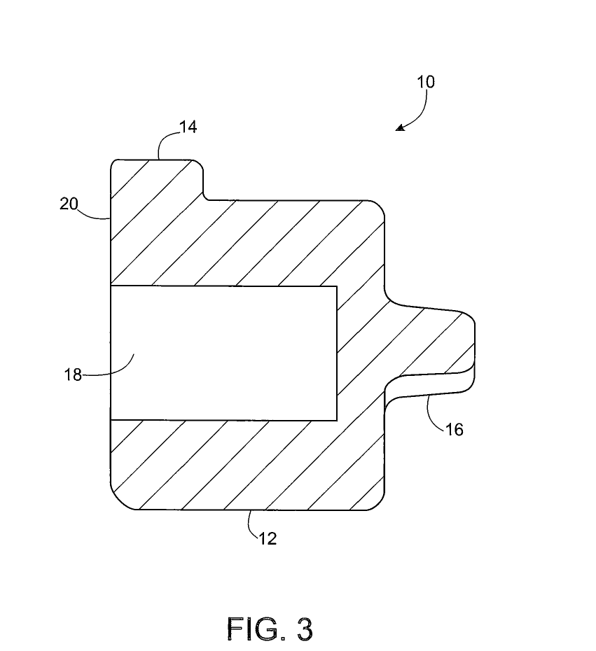

FIG. 3 shows a cut-away side view of the plug 10. The cylinder 12 has a uniform curved wall, except for the portion where the tab 14 extends from it. The tab terminates at the contact-facing side 20 of the plug 10, and forms a part of the contact-facing side. In this manner a stop (not shown) for the plug 10 also forms the position at which the plug 10 can be rotated to lock it into place. The bore 18 terminates before the raised indicia 16, allowing the raised indicia 16 to turn the plug 10 with little deformation, while the portion of the cylinder 12 around the bore 18 may deform to allow the plug 10 to be easily removed.

FIG. 4 shows a perspective view of a headphone 24 turned to show the bottoms of the earpieces 26. At the bottom of each earpiece 26, an audio jack 28 is disposed. As discussed, each audio jack comprises the same stereo connection to the headphones, allowing a user to plug an audio cord 30 to either earpiece 26 as desired, depending on the positioning of the user's audio equipment (not shown). In order to equalize the sound between both earpieces 26, an audio plug 32 is inserted into one audio jack 28, thereby creating a substantially air tight seal, and a plug 10 is inserted into the audio jack 28 on the opposite earpiece 26, also creating a substantially air tight seal.

The foregoing description of the preferred embodiment 10 of the invention is sufficient in detail to enable one skilled in the art to make and use the invention. It is understood, however, that the detail of the preferred embodiment presented is not intended to limit the scope of the invention, in as much as equivalents thereof and other modifications which come within the scope of the invention as defined by the claims will become apparent to those skilled in the art upon reading this specification.

What is claimed is:

1. A headphone having two earpieces, each earpiece having an audio jack, comprising:
a contact region having contacts for receiving and engaging an audio jack;
a plug region without contacts for receiving and engaging a plug, the plug region in communication with an outer portion of each earpiece;
a plug for releasably engaging the plug region; and
wherein the plug, when inserted into the plug region, creates an air-tight seal.

2. The headphone of claim 1 wherein the plug is cylindrical.

3. The headphone of claim 1 wherein the plug includes a hollow bore, the hollow bore open on a side of the plug facing the contact region.

4. The headphone of claim 1 wherein the plug includes a tab.

5. The headphone of claim 4 wherein the plug comprises an outer circumference.

6. The headphone of claim 5 wherein the tab is disposed on the outer circumference.

7. The headphone of claim 6 wherein the tab is disposed adjacent a side of the plug facing the contact region.

8. The headphone of claim 4 wherein the tab engages the earpiece, locking the plug in the headphone when the plug is inserted and turned.

9. The headphone of claim 1 further comprising a raised indicia.

10. The headphone of claim 8 wherein the raised indicia is disposed on a surface of the plug facing away from the contact region.

11. A headphone having two earpieces, each earpiece having an audio jack, comprising:
a contact region having contacts for receiving and engaging an audio jack;
a plug region without contacts for receiving and engaging a plug the plug region in communication with an outer portion of each earpiece;
a cylindrical plug for releasably engaging the plug region in a pressure fit, the plug comprising a raised indicia for removal and a tab for locking the plug in the earpieces; and
wherein the plug, when inserted into the plug region, creates an air-tight seal with the plug region.

11. A method of equalizing the sound produced by a headphone having two earpieces, comprising the steps of:
providing an audio jack receptacle in each earpiece;
providing a plug adapted to fit in each receptacle;
inserting an audio jack into the receptacle on a first earpiece;
inserting the plug into the audio jack on a second earpiece; and
transmitting an audio signal through the audio jack.

12. The method of claim 11 further comprising the step of removing the plug from the second earpiece and inserting an audio jack into the second earpiece.

13. The method of claim 11 further comprising the step of removing the audio jack from the first earpiece and inserting a plug in the first earpiece.
